(19) United States
(12) Patent Application Publication
(10) Pub. No.: US 2024/0394292 A1
(43) Pub. Date: Nov. 28, 2024

(54) ASSEMBLING OF ESSENTIALIZED DOCUMENTS BASED ON TASK SET ANALYSIS AND SUBJECT SKILL SCORING

(71) Applicant: International Business Machines Corporation, Armonk, NY (US)

(72) Inventors: Li Li Guan, Beijing (CN); Zhe Yan, Beijing (CN); Rong Zhao, Beijing (CN); Li Bo Zhang, Beijing (CN); Hao Xiang Wu, Beijing (CN)

(21) Appl. No.: 18/322,271

(22) Filed: May 23, 2023

(51) Int. Cl. G06F 16/335; G06F 16/31; G06F 40/30

(52) U.S. Cl. CPC G06F 16/335; G06F 16/322; G06F 40/30

(57) ABSTRACT

One or more systems, devices, computer program products and/or computer-implemented methods provided herein facilitate generation of an essentialized document that aids a technician in solving a problem with an asset. In an embodiment, the essentialized document is customizable based on technician skill. In another embodiment, the essentialized document is customizable based on the asset and asset components at issue.

### BACKGROUND

The subject disclosure relates to the assembling of documents for aiding a technician in solving a problem with an asset, and more specifically to the assembling of documents based on a problem of the asset and technician skill.

### SUMMARY

The following presents a summary to provide a basic understanding of one or more embodiments of the present disclosure. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products in accordance with the present disclosure.

Aspects of the present disclosure are directed toward a computer-implemented method comprising receiving, by a system operably coupled to a processor, a work order associated with a problem of an asset; determining, by the system, critical factors of related work orders; defining, by the system, the problem of the asset based on the critical factors and the work order; generating, by the system, user scores indicating a skill level of a user tasked with resolving the problem of the asset for asset components of the asset based on a user profile; determining a task-required score based on the user scores for the asset components associated with the problem and the user scores for related asset components; and generating, by the system, a customization guide based on the task-required score. Additional aspects of the present disclosure are directed to systems and computer program products configured to perform the methods described above.

### DESCRIPTION OF THE DRAWINGS

FIG. 1 illustrates a block diagram of an example, non-limiting system that can facilitate generation of an essentialized document that aids a technician in solving a problem with an asset, in accordance with one or more embodiments described herein.

FIG. 2 illustrates another block diagram of an example, non-limiting system that can facilitate generation of an essentialized document that aids a technician in solving a problem with an asset, in accordance with one or more embodiments described herein.

FIG. 3 illustrates another block diagram of an example, non-limiting system that can facilitate generation of an essentialized document that aids a technician in solving a problem with an asset, in accordance with one or more embodiments described herein.

FIG. 4 illustrates another block diagram of an example, non-limiting system that can facilitate generation of an essentialized document that aids a technician in solving a problem with an asset, in accordance with one or more embodiments described herein.

FIG. 5 illustrates another block diagram of an example, non-limiting system that can facilitate generation of an essentialized document that aids a technician in solving a problem with an asset, in accordance with one or more embodiments described herein.

FIG. 6A illustrates another block diagram of an example, non-limiting system that can facilitate generation of an essentialized document that aids a technician in solving a problem with an asset, in accordance with one or more embodiments described herein.

FIG. 6B illustrates another block diagram of an example, non-limiting system that can facilitate generation of an essentialized document that aids a technician in solving a problem with an asset, in accordance with one or more embodiments described herein.

FIG. 6C illustrates another block diagram of an example, non-limiting system that can facilitate generation of an essentialized document that aids a technician in solving a problem with an asset, in accordance with one or more embodiments described herein.

FIG. 7 illustrates another block diagram of an example, non-limiting system that can facilitate generation of an essentialized document that aids a technician in solving a problem with an asset, in accordance with one or more embodiments described herein.

FIG. 8 illustrates another block diagram of an example, non-limiting system that can facilitate generation of an essentialized document that aids a technician in solving a problem with an asset, in accordance with one or more embodiments described herein.

FIG. 9 illustrates another block diagram of an example, non-limiting system that can facilitate generation of an essentialized document that aids a technician in solving a problem with an asset, in accordance with one or more embodiments described herein.

FIG. 10 illustrates a flow diagram of an example, non-limiting computer-implemented method in accordance with one or more embodiments described herein.

FIG. 11 illustrates a flow diagram of an example, non-limiting computer-implemented method in accordance with one or more embodiments described herein.

FIG. 12 illustrates a flow diagram of an example, non-limiting computer-implemented method in accordance with one or more embodiments described herein.

FIG. 13 illustrates a block diagram of an example, computing environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

An organization or other entity may possess various assets that encounter problems that need to be addressed for the proper operation of those assets. The organization or other entity may employ one or more technicians to diagnose problems with assets, find suitable solutions for the various problems that may be encountered by the assets, and carry out tasks related to the solutions. The one or more technicians can interact with many different types of assets and therefore can encounter many different types of problems involving various asset components. It is likely that a technician possesses varying skill levels with respect to different types of assets, asset components, and asset problems. Also, different technicians can possess different levels of skill.

To solve a problem with an asset, a technician generally must first understand the problem. Some problems with assets can be difficult to define. A technician can be alerted to a problem with an asset via a work order. The work order can comprise key information regarding the nature of the problem including the affected asset and/or asset component, a notification from the asset, and any relevant users and activities. Although a work order may alert a technician to a problem, the work order may still be missing important context and may not define the problem. In an embodiment, problems with assets can be related to a past status of the asset. Therefore, a technician may need to combine past inspection results and/or maintenance information to discover relevant factors to the problem. For example, a work order may indicate that a drive module is overheating but may not indicate other relevant factors such as the drive module being recently replaced or that an air pump was recently repaired.

Data may be accessible to a technician that comprises historical inspection results and maintenance data. The data can comprise historical work orders as well as other documents comprising inspection results, maintenance data, instructional information, and informational or reference documents. It is not efficient and is often impractical for a technician to manually locate the information needed from a large body of documents. Further, even once a technician receives documents comprising relevant data, the documents may not be understood by the technician. For example, a technician may be unfamiliar with some of the vocabulary used in a document. For another example, a technician may possess a low skill level with respect to an asset component that is at issue in the problem, and as a result may not understand the information in the document. Additionally, relevant documents may possess redundant information, further hindering the efficiency of a technician attempting to solve a problem while utilizing relevant contextual documents.

It is therefore desirable for a technician to be able to efficiently receive an essentialized document that comprises information relevant to the problem with an asset that is understandable by the technician working to solve the problem. The essentialized document can be a customized document that concisely presents relevant information to the technician and omits redundant or irrelevant information. The essentialized document can provide necessary contextual information such as past statuses of the affected asset or asset components to the technician. The essentialized document can be annotated to emphasize or explain certain aspects of the document. For example, the essentialized document can comprise highlights and explanatory comments. The essentialized document can further be customized reflect the skill level of the technician working on the problem. For example, if a technician has a low skill level with respect to an asset component, the essentialized document can include definitions of certain terms, additional instructions or detail regarding an asset component or an associated task, and/or references to additional resources. If a technician possesses a high skill level with respect to an asset component at issue, explanatory details as to that asset component can be omitted from the essentialized document. The essentialized document may therefore have a customizable granularity depending on user skill.

In another example, an asset component, such as an air pump, may be affected by a problem. A technician may be largely unfamiliar with air pumps and therefore possess a low skill level for such an asset component. The technician may, however, possess a high skill level or familiarity with a related asset component. For example, the technician may be highly skilled with hydraulic pumps. Here, the essentialized document can point out similarities and differences between an air pump and a hydraulic pump. Such a comparison can facilitate quick learning by the technician. Accordingly, an essentialized document can facilitate efficient problem solving by technicians. The aid of an essentialized document may allow a technician with a low skill level in a certain area to solve a problem efficiently that the technician may have been otherwise incapable of solving or would have been relatively inefficient in solving. Additionally, the aid of an essentialized document can facilitate high efficiency of a technician with a high skill level in a certain area by removing redundant or known information from the documents that the technician may review for the purpose of addressing a problem.

Embodiments described herein facilitate the assembling of essentialized documents based various factors associated with the problem of the asset and the skill level or levels associated with the technician who is attempting to solve the problem.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however in various cases, that the one or more embodiments can be practiced without these specific details. As used herein, the term “entity” can refer to a machine, device, component, hardware, software, smart device and/or human.

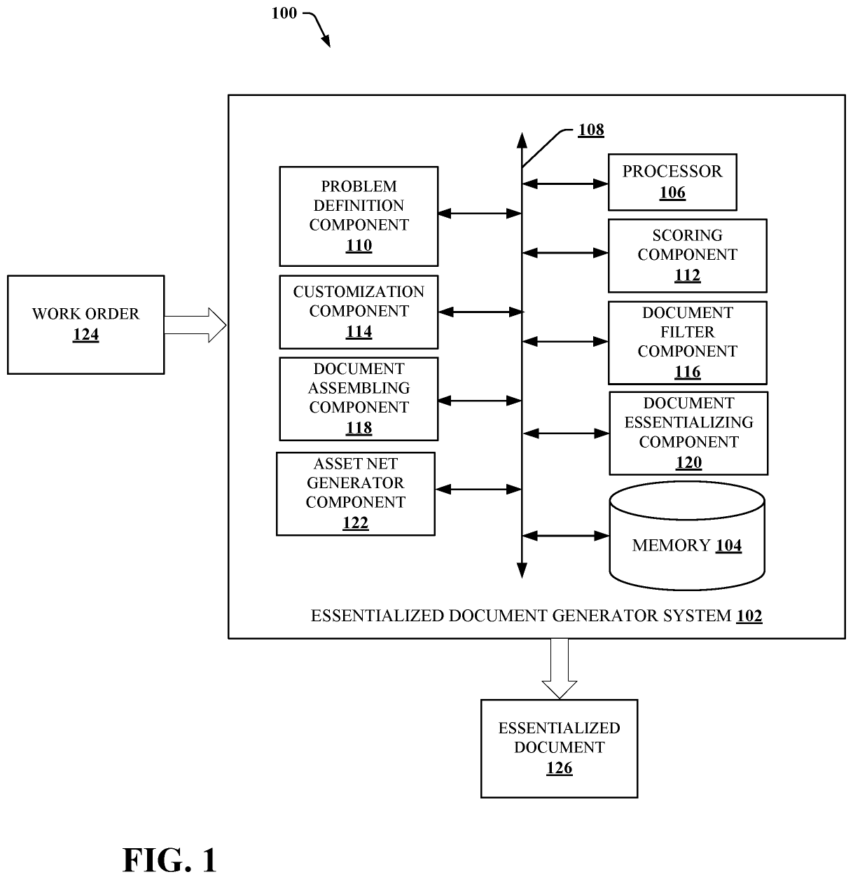

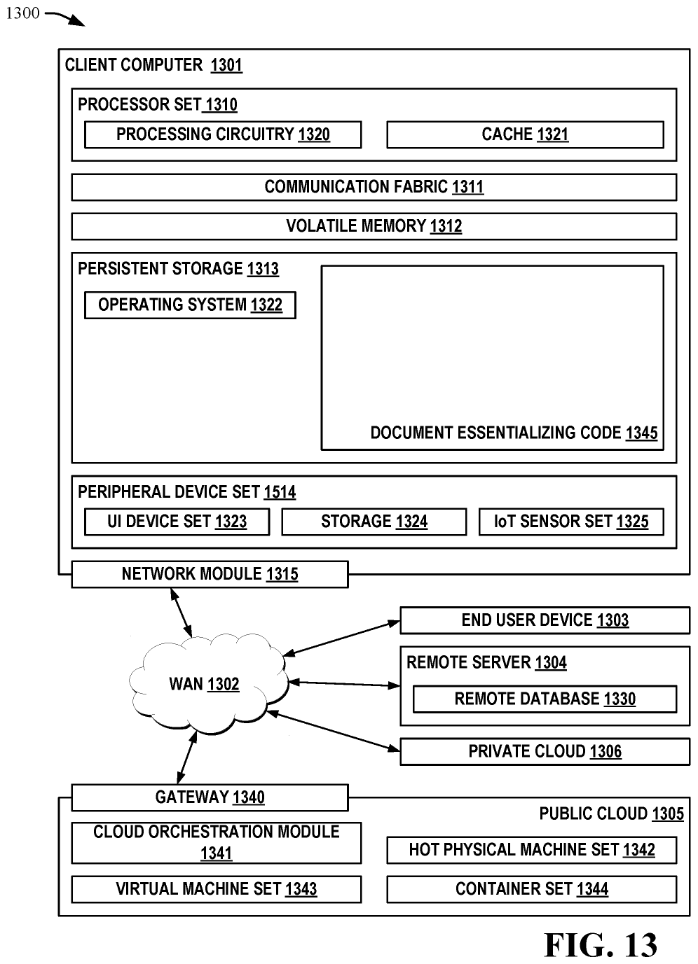

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting systems 100-900 as illustrated at FIGS. 1-9, and/or systems thereof, can further comprise, be associated with and/or be coupled to one or more computer and/or computing-based elements described herein with reference to an operating environment, such as the operating environment 1300 illustrated at FIG. 13. In one or more described embodiments, computer and/or computing-based elements can be used in connection with implementing one or more of the systems, devices, components and/or computer-implemented operations shown and/or described in connection with FIGS. 1-9 and/or with other figures described herein.

FIG. 1 illustrates a block diagram of an example, non-limiting essentialized document generator system 102 that facilitates generation of an essentialized document that aids a technician in solving a problem with an asset in accordance with one or more embodiments described herein. As illustrated at FIG. 1, the essentialized document generator system 102 can comprise one or more components, such as a memory 104, processor 106, bus 108, problem definition component 110, scoring component 112, customization component 114, document filter component 116, document assembling component 118, document essentializing component 120, and/or asset net generator component 122. Generally, essentialized document generator system 102 can facilitate generation of an essentialized document or documents that aid one or more technicians in solving a problem associated with an asset based on the problem of the asset and the skill level or levels associated with the technician who is attempting to solve the problem.

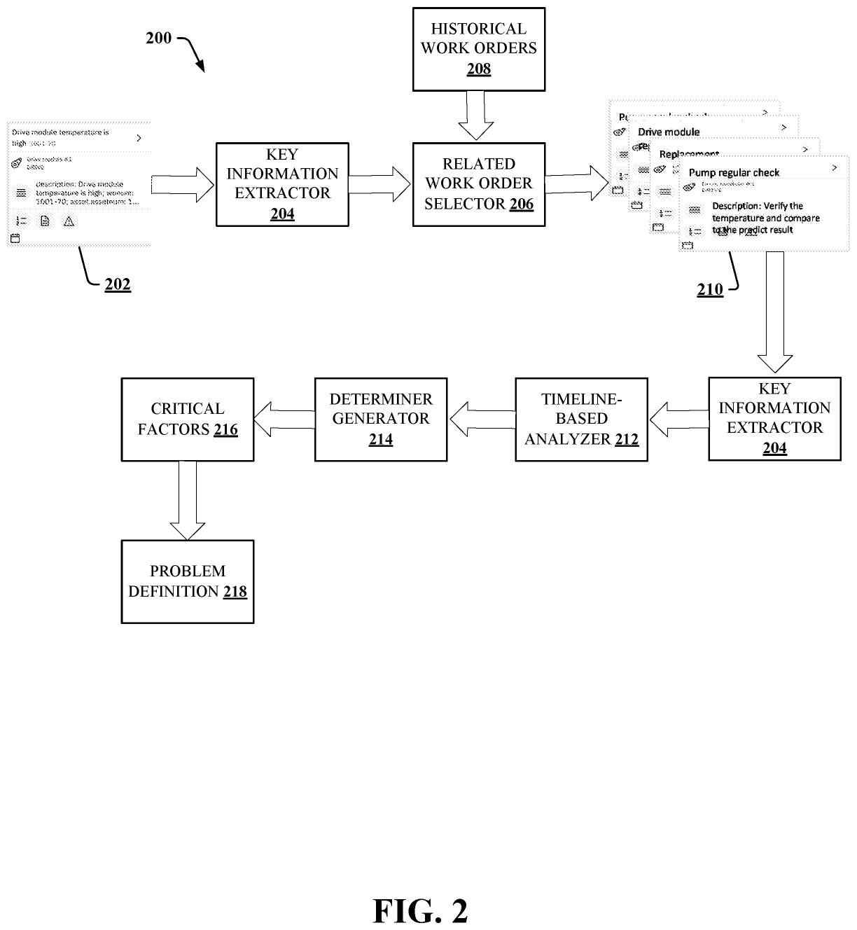

The problem definition component 110 can receive a work order 124 associated with a problem of an asset. The work order 124 can comprise, for example, information relating to the relevant asset, asset components, indicators from assets, event or activity associated with the problem of the asset, and/or users associated with the problem of the asset. The problem definition component 110 can further determine critical factors of related work orders. The determination of critical factors is further explained with reference to FIG. 2 below. The problem definition component 110 can further define the problem of the asset based on the critical factors and the work order 124.

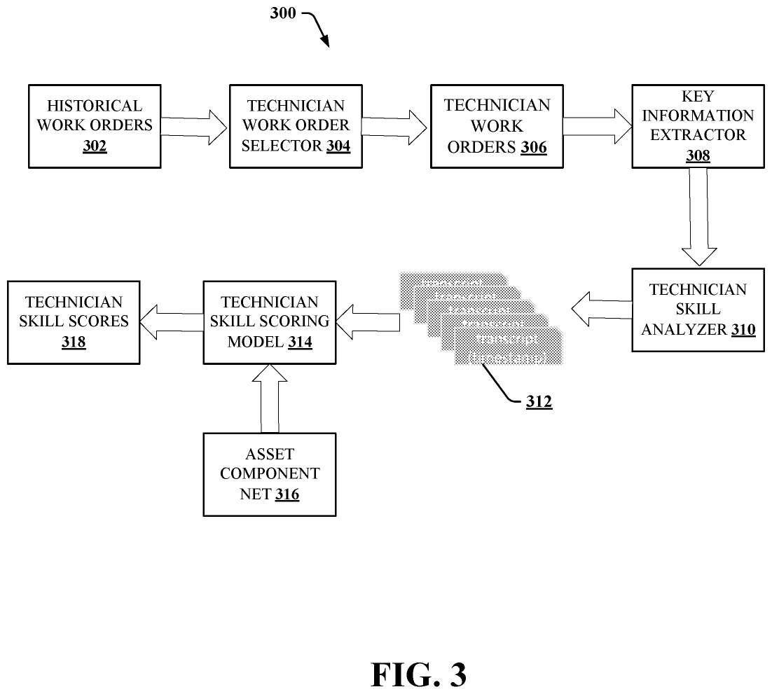

The scoring component 112 can generate user scores indicating a skill level of a user tasked with resolving the problem of the asset for each asset component of the asset based on a user profile. The user can be a technician. In an embodiment, the scoring component 112 can generate a score for a user for each asset component of an asset associated with the problem. In another embodiment, the scoring component 112 can also generate a score for a user for additional asset components that are not directly associated with the problem. In an embodiment, the user profile can comprise historical work orders associated with the user. In another embodiment, the user profile can comprise a work log, user self-assessments, amount or duration of user experience, and review comments. In an embodiment, a user profile can comprise various user scores associated with various assets, asset components, and/or types of asset problems. The generating of user scores is further explained with reference to FIG. 3 below.

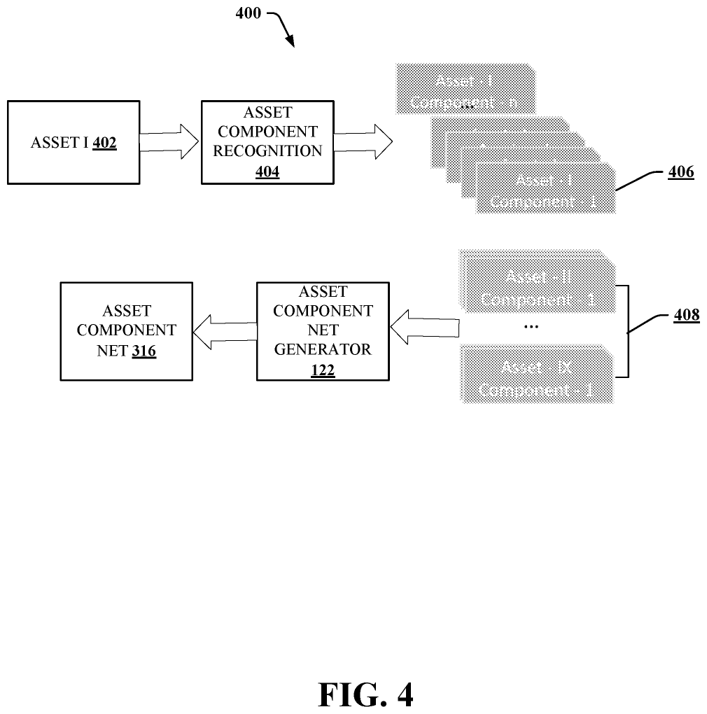

In an embodiment, user scores can be technician skill scores 318. Technician skill scores 318 of the user can be based in part on an asset component net 316. The asset net generator component 122 can identify each asset component of an asset and cluster the asset components based on semantic similarity to generate an asset component net such as asset component net 316. The generating of asset component net 316 is further explained with reference to FIG. 4 below.

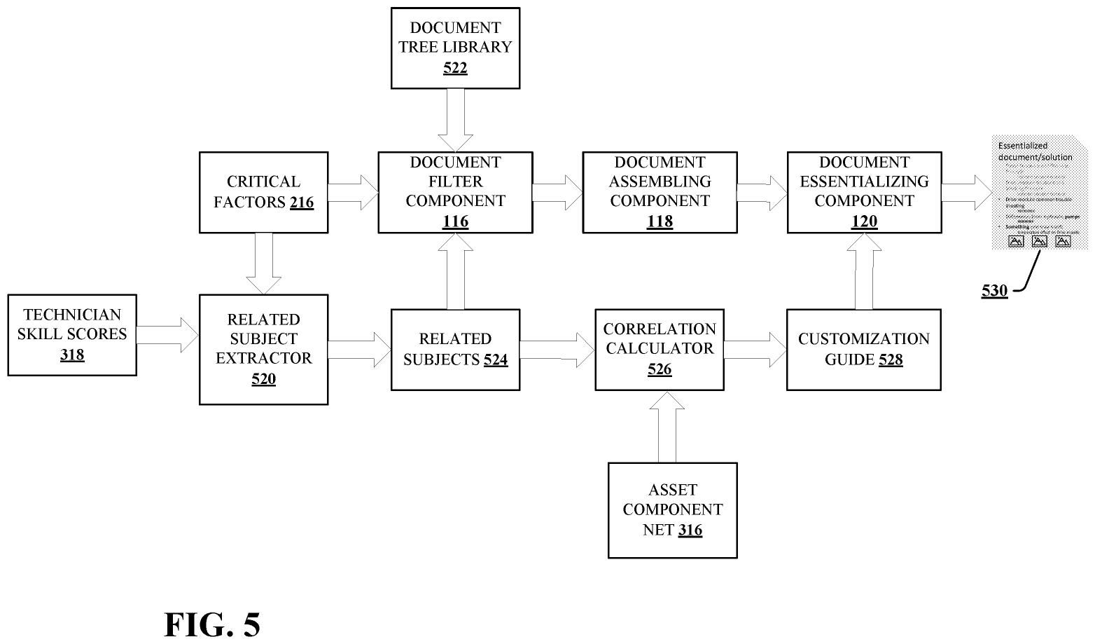

The customization component 114 can determine a task-required score based on the user scores for the asset components associated with the problem and the user scores for related asset components. The customization component 114 can further generate a customization guide based on the task-required score. The generation of the customization guide is explained further in reference to FIG. 5 below.

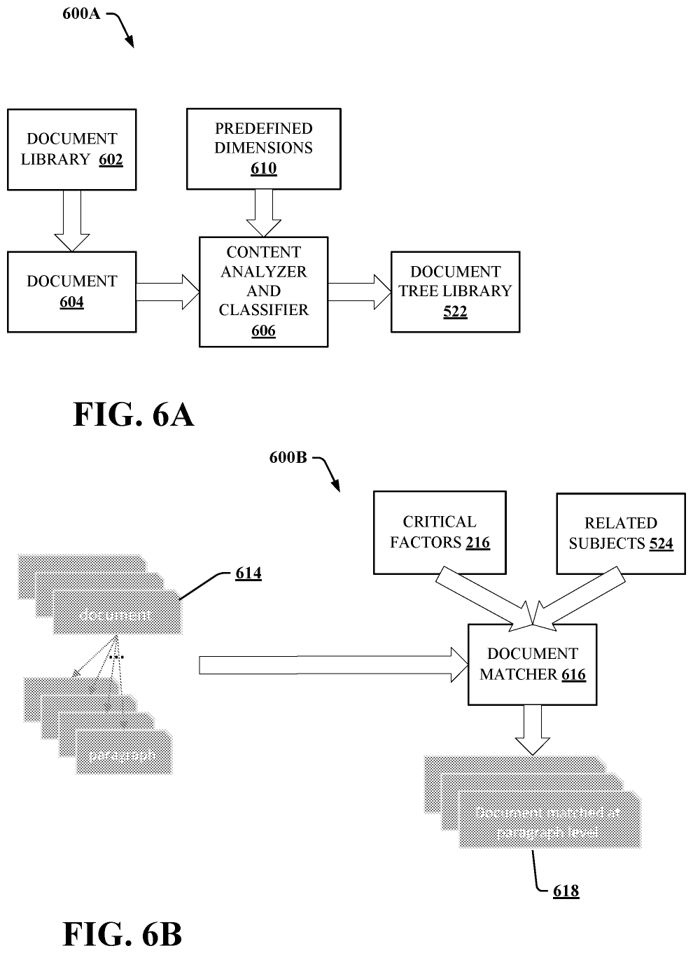

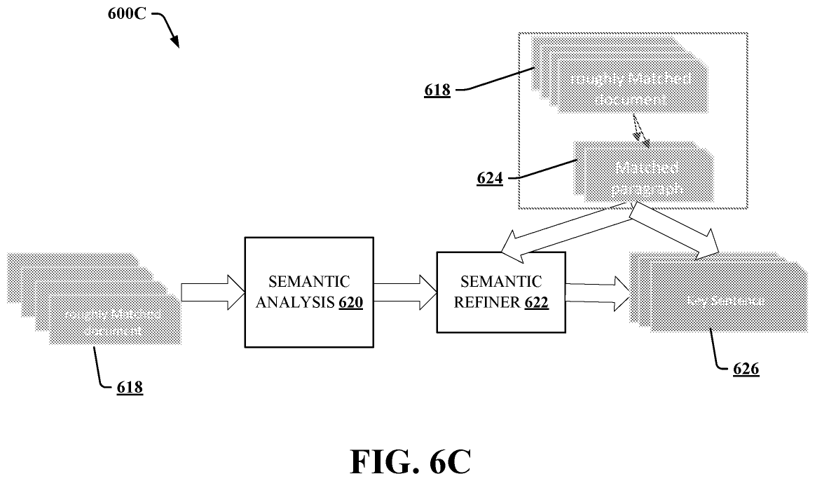

The document filter component 116 can generate a coarse-grained document tree for each document in a document library based on predefined dimensions and match the documents at a paragraph granularity based on the critical factors and related asset components. For example, the predefined dimensions can be a topic, asset, brand, field, and/or customer. The document filter component 116 can further perform fine-grained semantic analysis on content of matched documents at a sentence level. The generation of the document trees, matching of documents, and semantic analysis is further explained with reference to FIGS. 6A-C below. The document filter component 116 facilitates the filtering of related content from multiple documents wherein the documents can comprise relevant information to solve the problem of the asset as well as information relevant to customization for the technician or other user.

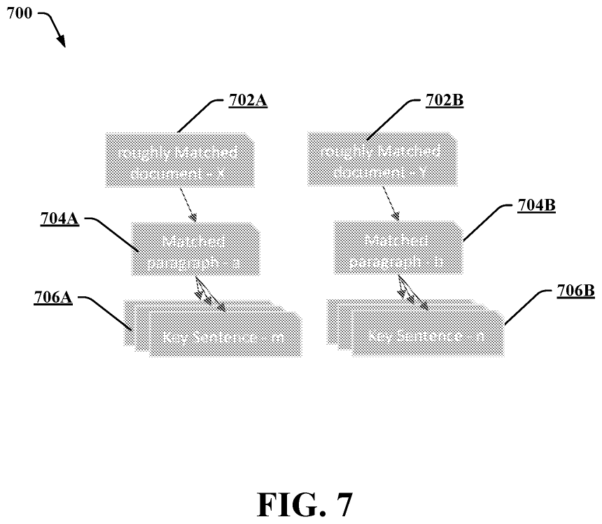

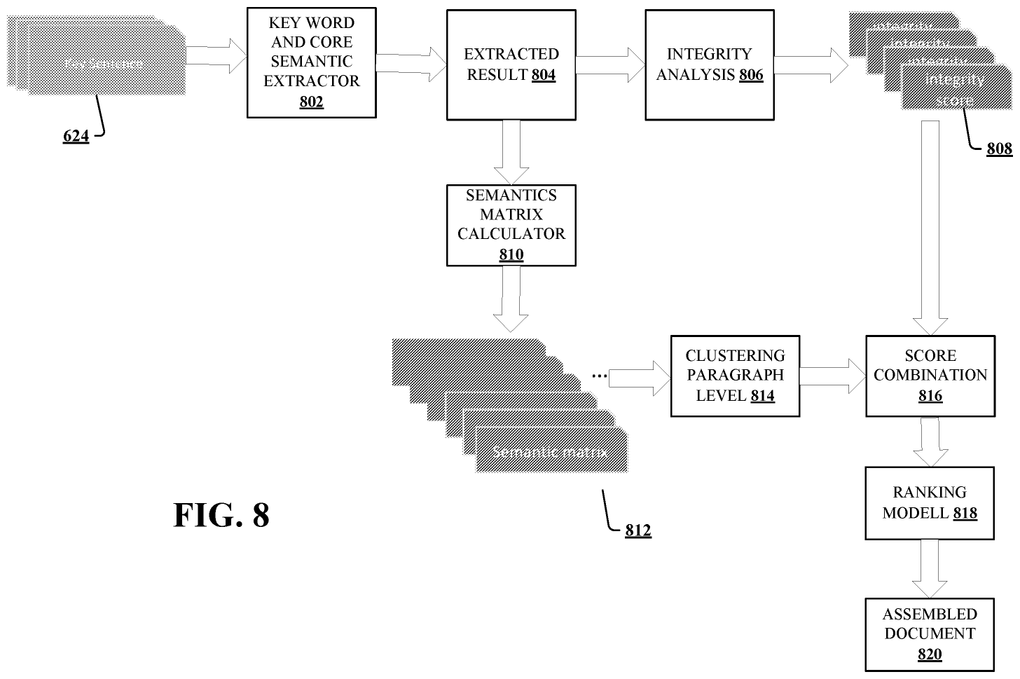

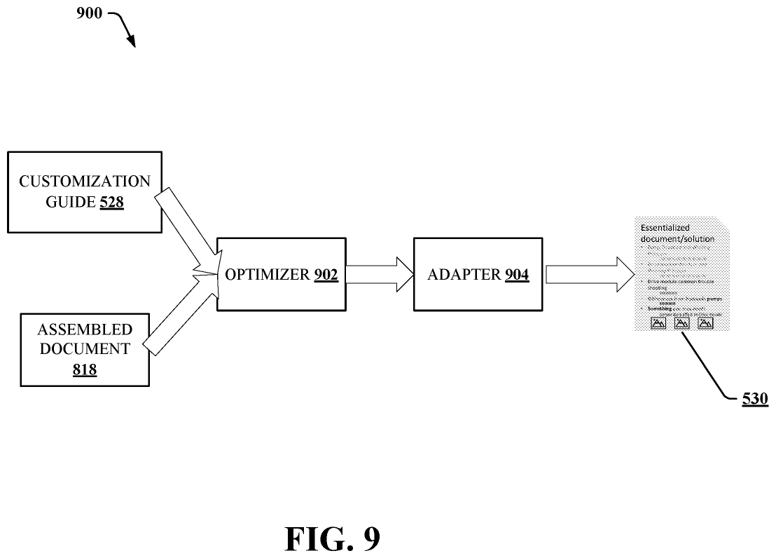

The document assembling component 118 can generate an assembled document based on an integrity analysis and a semantic similarity analysis on the content of related paragraphs in the matched documents. The generation of the assembled document is further explained with reference to FIGS. 7 and 8 below. The document assembling component 118 can facilitate the prevention of redundant content appearing in the essentialized document 126. The document essentializing component 120 can that generate an essentialized document 126 based on the assembled document and the customization guide. The generation of the essentialized document is further explained with reference to FIG. 9 below.

The various devices (e.g., system 100) and components (memory 104, processor 106, problem definition component 110, scoring component 112, customization component 114, document filter component 116, document assembling component 118, document essentializing component 120, asset net generator component 122, and/or other components) of system 100 can be connected either directly or via one or more networks. Such networks can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology.

FIG. 2 illustrates another block diagram of an example, non-limiting system that can facilitate generation of an essentialized document that aids a technician in solving a problem with an asset, in accordance with one or more embodiments described herein. Repetitive description of like elements and/or processes employed in respective embodiments is omitted for sake of brevity. As indicated previously, description relative to an embodiment of FIG. 1 can be applicable to an embodiment of FIG. 2. Likewise, description relative to an embodiment of FIG. 2 can be applicable to an embodiment of FIG. 1.

The system 200 demonstrates a determination of critical factors and a problem definition. Work order 202 is an example work order that can be received by a system. Work order 202 indicates a problem with an asset wherein the temperature of a drive module of an asset is high. Key information can be extracted from the work order by a key information extractor 204. The key information extractor can extract, for example, information relating to the relevant asset and asset components, indicators from assets, event or activity associated with the problem of the asset, and/or users associated with the problem of the asset.

Based on the key information, a related work order selector 206 can determine related work orders 210 by selecting them from historical work orders 208 that can be stored in a memory. Related work orders 210 may be, for example, past work orders for the asset. The key information extractor 204 can extract key information from the related work orders. The related work orders 210 and the associated extracted key information can be analyzed by timeline-based analyzer 212 which considers the timeline of the related work orders 210.

Based on the analysis of the timeline-based analyzer 212, a determinator generator 214 can generate determiners and their weights. For example, weight can be a function of time, frequency, topic, and feedback related to the related work orders 210. Based on the determiners and their weight, the problem definition component 110 can determine critical factors 216 of the problem. In an embodiment, critical factors 216 of a problem can relate to a past status of the affected asset. For example, a critical factor 216 can be that a relevant asset component has been repaired three times within the last several weeks. For another example, a critical factor 216 can be that the relevant asset component has been replaced since the last repair. For another example, a critical factor 216 can be the results of recent inspections.

Based on the critical factors 216, the problem definition component 110 can determine a problem definition 218. The problem definition can be, for example, the drive module for an asset is overheating one week after the air pump of the asset that functions to cool the drive module was replaced. In an embodiment, the problem definition can be communicated to the technician or other entity via a user interface (not pictured). The problem definition can help a technician quickly determine the problem with the asset.

FIG. 3 illustrates another block diagram of an example, non-limiting system that can facilitate generation of an essentialized document that aids a technician in solving a problem with an asset, in accordance with one or more embodiments described herein. Specifically, the system 300 facilitates the determination of user scores from a user profile such as by scoring component 112. Repetitive description of like elements and/or processes employed in respective embodiments is omitted for sake of brevity. As indicated previously, description relative to an embodiment of FIGS. 1 and 2 can be applicable to an embodiment of FIG. 3. Likewise, description relative to an embodiment of FIG. 3 can be applicable to an embodiment of FIGS. 1 and 2.

The system 300 comprises historical work orders 302. Historical work orders 302 can be stored in a memory. Technician work order selector 304 can select the work orders of historical work orders 302 that are associated with a technician or other user currently attempting to solve a problem to generate technician work orders 306. Key information extractor 308 can extract key information from the technician work orders 306. The technician skill analyzer 310 can analyze the key information extracted from the technician work orders 306. The technician skill analyzer 310 can also analyze a work log associated with the user, user self-assessments, amount or duration of user experience, and review comments. Based on its analysis, the technician skill analyzer 310 can generate transcripts 312. In an embodiment, the transcripts 312 can correspond to various asset components. In an embodiment, the transcripts 312 can be in excel format. In an embodiment, the transcripts are associated with a weight.

Based on the transcripts 312 and the asset component net 316, a technician skill scoring model 314 can determine technician skill scores 316. In an embodiment, the technician skill scores 316 can represent the respective skills of a technician or other user as they relate to one or more asset components. For example, a technician can have a technician subject skill score of 30 for an air pump.

FIG. 4 illustrates another block diagram of an example, non-limiting system that can facilitate generation of an essentialized document that aids a technician in solving a problem with an asset, in accordance with one or more embodiments described herein. Specifically, the system 400 facilitates generation of an asset component net such as can be carried out by asset net generator component 122. Repetitive description of like elements and/or processes employed in respective embodiments is omitted for sake of brevity. As indicated previously, description relative to an embodiment of FIGS. 1-3 can be applicable to an embodiment of FIG. 4. Likewise, description relative to an embodiment of FIG. 4 can be applicable to an embodiment of FIGS. 1-3.

The system 400 comprises an example asset I 402. Asset component recognition 404 can identify the asset components 406 of the asset I 402. Asset component recognition 404 can similarly recognize the asset components of other assets as well. For example, asset component recognition can identify the asset components of assets II-IX 408. The asset component net generator 122 can generate an asset component net 316 based on the identified asset components of one or more assets. In an embodiment, the asset net generator 122 can comprise asset component recognition 404. In an embodiment, the asset net generator 122 can determine the asset component net 316 by clustering the asset components based on word similarity. In an embodiment, the asset net generator 122 can determine the asset component net 316 based on other similarities and correlations between the asset components.

FIG. 5 illustrates another block diagram of an example, non-limiting system that can facilitate generation of an essentialized document that aids a technician in solving a problem with an asset, in accordance with one or more embodiments described herein. Repetitive description of like elements and/or processes employed in respective embodiments is omitted for sake of brevity. As indicated previously, description relative to an embodiment of FIGS. 1-4 can be applicable to an embodiment of FIG. 5. Likewise, description relative to an embodiment of FIG. 5 can be applicable to an embodiment of FIGS. 1-4.

The system 500 illustrates a document processor flow for the generation of an essentialized document. A related subject extractor 520 can receive critical factors 216 and technician skill scores 318. The related subject extractor 520 can determine related subjects 524 for a problem. For example, if problem is associated with an air pump, a related subject can be a hydraulic pump.

The correlation calculator 526 can determine a related subject skill score and a task-required subject skill score. For example, a technician can have a related subject skill score of 85 for a hydraulic pump. A customization guide 528 can be determined by customization component 116. For example, the customization component 116 can determine the customization guide 528 based on the user scores, the related subject skill scores, and the relationships between asset components and related subjects as defined by the asset component net 316. For example, the relationships between asset components and related subjects can be based on related subject semantic correlation. In an embodiment, the customization component 116 comprises the correlation calculator 526.

The customization guide 528 can comprise instructions to generate the essentialized document. In an embodiment, the customization guide 528 can comprise instructions to include a comparison of two or more asset components in the essentialized document. In an embodiment, the customization guide 528 can comprise instructions to remove information related to an asset component. In an embodiment, the customization guide 528 can comprise instructions to add additional information relating to the problem or tasks related to a solution to the problem. For example, in response to a determination that a technician possesses technician skill scores of 30 for air pumps, 85 for hydraulic pumps, and 90 for pump foundation, the customization guide can comprise instructions to include a comparison of hydraulic pumps and air pumps, remove instructions regarding a pump foundation (due to the technician's high score in this area), and to add information relating to the temperature effect on a drive module of an air pump.

The document filter component 116 can filter documents based on the related subject skill scores and the task-required subject skill scores. The document filter component 116 can further match documents based on document trees of the document tree library 522, the related subjects 524, and the critical factors 216. The document assembling component 118 can generate an assembled document based on the matched documents. The document essentializing component can generate an essentialized document based on the assembled document and the customization guide 528.

FIG. 6A illustrates another block diagram of an example, non-limiting system that can facilitate generation of an essentialized document that aids a technician in solving a problem with an asset, in accordance with one or more embodiments described herein. Specifically, the system 600A facilitates the generation of document trees and a document tree library. Repetitive description of like elements and/or processes employed in respective embodiments is omitted for sake of brevity. As indicated previously, description relative to an embodiment of FIGS. 1-5 can be applicable to an embodiment of FIG. 6A. Likewise, description relative to an embodiment of FIG. 6A can be applicable to an embodiment of FIGS. 1-5.

A document 604 of a document library 602 can be analyzed by content analyzer 606. A document 604 can be for example, a work order. A document 604 can be for example, a reference document. A document 604 can be, for example an inspection record. The content analyzer and classifier 606 can extract the central ideas from a document 604 at different granularities based on predefined dimensions. For example, the content analyzer and classifier 606 can extract a central idea from each paragraph of a document. The central ideas can be formulated as “subject+verb” for each paragraph. The content analyzer and classifier can further build a document tree that can be stored in document tree library 522.

FIG. 6B illustrates another block diagram of an example, non-limiting system that can facilitate generation of an essentialized document that aids a technician in solving a problem with an asset, in accordance with one or more embodiments described herein. Repetitive description of like elements and/or processes employed in respective embodiments is omitted for sake of brevity. As indicated previously, description relative to an embodiment of FIGS. 1-6A can be applicable to an embodiment of FIG. 6B. Likewise, description relative to an embodiment of FIG. 6B can be applicable to an embodiment of FIGS. 1-6A.

Specifically, the system 600B facilitates document matching at a paragraph granularity based on a document tree 604B. A document matcher 616 can match documents 614 at a paragraph level based on their respective document trees, critical factors 216 and related subjects 524. The document matcher 616 can generate documents matched at a paragraph level 618.

FIG. 6C illustrates another block diagram of an example, non-limiting system that can facilitate generation of an essentialized document that aids a technician in solving a problem with an asset, in accordance with one or more embodiments described herein. Repetitive description of like elements and/or processes employed in respective embodiments is omitted for sake of brevity. As indicated previously, description relative to an embodiment of FIGS. 1-6B can be applicable to an embodiment of FIG. 6C. Likewise, description relative to an embodiment of FIG. 6C can be applicable to an embodiment of FIGS. 1-6B.

Specifically, the system 600C facilitates the determination of key sentences. Matched documents 618 are subjected to semantic analysis 620. Semantic analysis 620 can be fine grained semantic analysis such as analysis at a sentence level and can determine the semantics of relevant paragraphs in context. The semantic refiner 622 can refine the semantics at different levels of the document tree and update the document tree with the refined results. The semantic refiner 622 can iteratively refine the semantics to produce a more precise document tree.

FIG. 7 illustrates another block diagram of an example, non-limiting system that can facilitate generation of an essentialized document that aids a technician in solving a problem with an asset, in accordance with one or more embodiments described herein. Repetitive description of like elements and/or processes employed in respective embodiments is omitted for sake of brevity. As indicated previously, description relative to an embodiment of FIGS. 1-6C can be applicable to an embodiment of FIG. 7. Likewise, description relative to an embodiment of FIG. 7 can be applicable to an embodiment of FIGS. 1-6C.

Specifically, FIG. 7 is an example illustration of roughly matched documents 702A and 702B. The paragraphs of document 702A are designated 704A. The paragraphs 704A are roughly matched to the paragraphs 704B. Several key sentences 706A and 706B can be extracted from respective matched paragraphs 704A and 704B.

FIG. 8 illustrates another block diagram of an example, non-limiting system that can facilitate generation of an essentialized document that aids a technician in solving a problem with an asset, in accordance with one or more embodiments described herein. Repetitive description of like elements and/or processes employed in respective embodiments is omitted for sake of brevity. As indicated previously, description relative to an embodiment of FIGS. 1-7 can be applicable to an embodiment of FIG. 8. Likewise, description relative to an embodiment of FIG. 8 can be applicable to an embodiment of FIGS. 1-7.

Specifically, the system 800 facilitates the generation of an assembled document 818 as can be carried out by document assembling component 118. Key word and core semantics extractor 802 can extract key words and core semantics from key sentences 624 to generate an extracted result 804. The extracted result 804 can be subject to integrity analysis 806. The integrity analysis 806 results in integrity scores 808 associated with the paragraphs 624. The integrity analysis 806 can be based on an analysis of sentence correlation, completeness, and weight:

$${f}_{integrity} = f ( Completeness , Correlation , weight ) = Completeness * Correlation * weight$$

Sentence correlation can be based on parallels, cause and consequence, turn, and explanation. The sentence correlation can be converted to sentence weight. Sentence completion can be based on a mapping of keywords.

The extracted result 804 can also be subjected to semantics matrix calculator 810 which can perform semantic similarity analysis on the extracted result 804 to result in semantic matrix values 812. The semantic similarity analysis can be based on completeness:

$${f}_{similarity matrix} = g ( Completeness )$$

Semantic matrix values 812 can be subject to clustering at a paragraph level 814. At score combination 816, the similarity matrix values and integrity scores associated with the paragraphs are combined and the combinations are ranked by a ranking model 818. Based on the rankings of the ranking model 818 the document assembling component 118 generates an assembled document 820. In an embodiment, the document assembling component 118 can identify paragraphs for the addition of a reference or other supplementary information.

FIG. 9 illustrates another block diagram of an example, non-limiting system that can facilitate generation of an essentialized document that aids a technician in solving a problem with an asset, in accordance with one or more embodiments described herein. Specifically, the system 900 illustrates generation an essentialized document based on the assembled document and the customization guide as can be carried out by document essentializing component 120. An optimizer 902 can generate an essentialized document based on the assembled document 818 and the customization guide 528. For example, the customization guide 528 can comprise instructions that instruct the document essentializing component 120 to add or omit certain information. For another example, the assembled document can indicate redundant information that can be omitted from the essentialized document. An adapter 904 can adapt the essentialized document into a final form to be presented by the technician such as essentialized document 530.

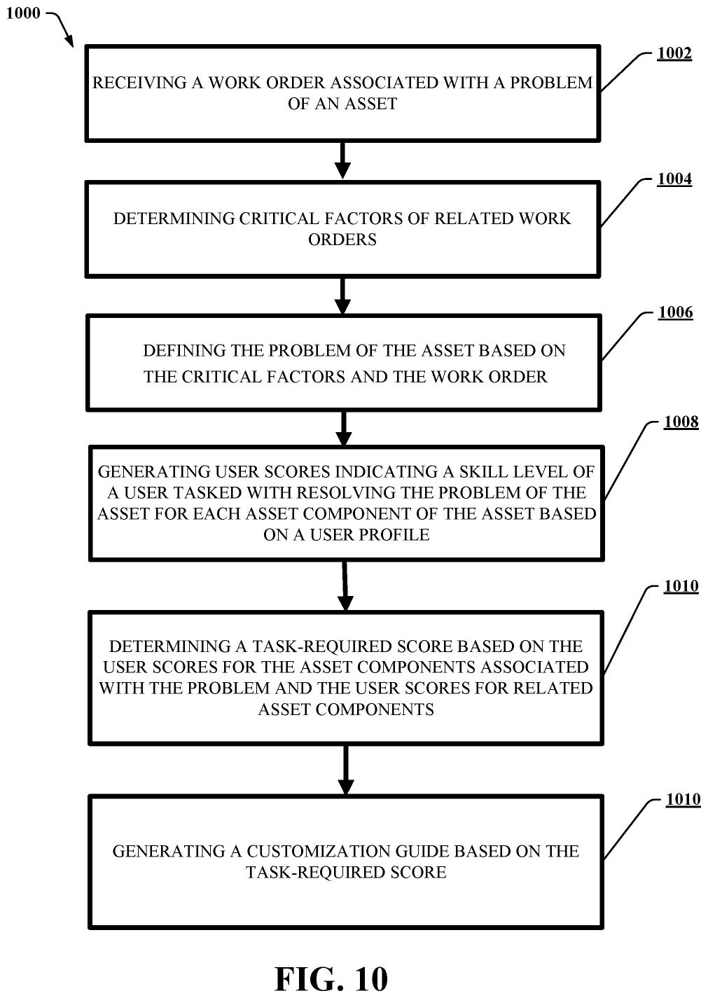

Next, FIG. 10 illustrates a flow diagram of an example, non-limiting method 1000 that can facilitate generation of an essentialized document that aids a technician in solving a problem with an asset, in accordance with one or more embodiments described herein. Repetitive description of like elements and/or processes employed in respective embodiments is omitted for sake of brevity. At 1002, the non-limiting method 1000 can comprise receiving (e.g. by problem definition component 110) a work order associated with a problem of an asset. At 1004, the non-limiting method 1000 can comprise determining (e.g., by problem definition component 110) critical factors of related work orders. At 1006, the non-limiting method 1000 can comprises defining (e.g., by problem definition component 110) the problem of the asset based on the critical factors and the work order. At 1008, the non-limiting method 1000 can comprise generating (e.g., by scoring component 112) user scores indicating a skill level of a user tasked with resolving the problem of the asset for each asset component of the asset based on a user profile. At 1010 the non-limiting method 1000 can comprise generating (e.g., by scoring component 112) user scores indicating a skill level of a user tasked with resolving the problem of the asset for each asset component of the asset based on a user profile. At 1010, the non-limiting method 1000 can comprise generating (e.g., by customization component 114) a customization guide based on the task-required score.

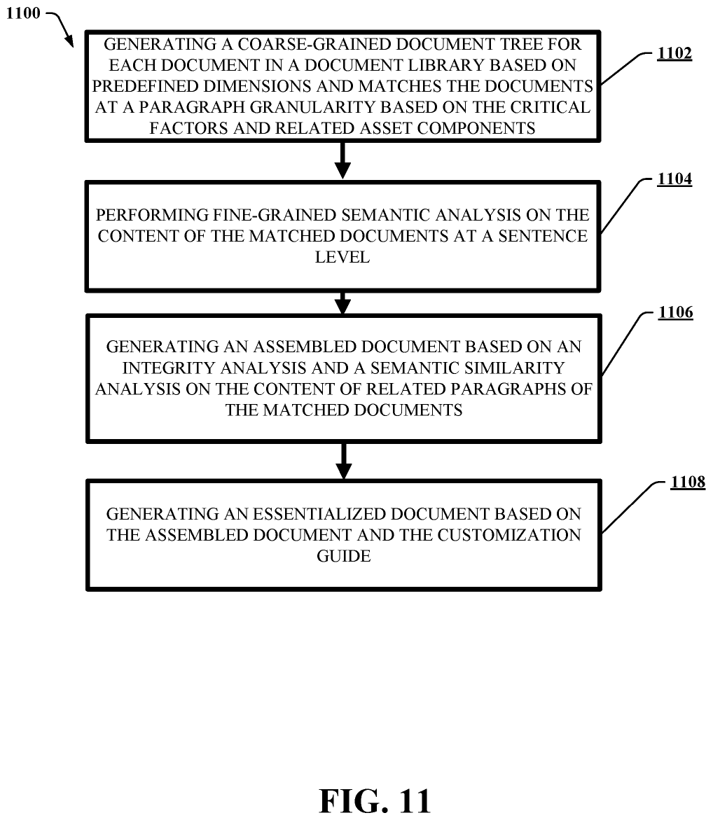

Next, FIG. 11 illustrates a flow diagram of an example, non-limiting method 1100 that can facilitate generation of an essentialized document that aids a technician in solving a problem with an asset. Repetitive description of like elements and/or processes employed in respective embodiments is omitted for sake of brevity. At 1102, the non-limiting method 1100 can comprise generating (e.g., by document filtering component 116) a coarse-grained document tree for each document in a document library based on predefined dimensions and matches the documents at a paragraph granularity based on the critical factors and related asset components. At 1104, the non-limiting method 1100 can comprise performing (e.g., by document filtering component 116) fine-grained semantic analysis on the content of the matched documents at a sentence level. At 1106, the non-limiting method 1100 can comprise generating (e.g., by document assembling component 118) an assembled document based on an integrity analysis and a semantic similarity analysis on the content of related paragraphs of the matched documents. At 1108, the non-limiting method 1100 can comprise generating (e.g., by document essentializing component 120) an essentialized document based on the assembled document and the customization guide.

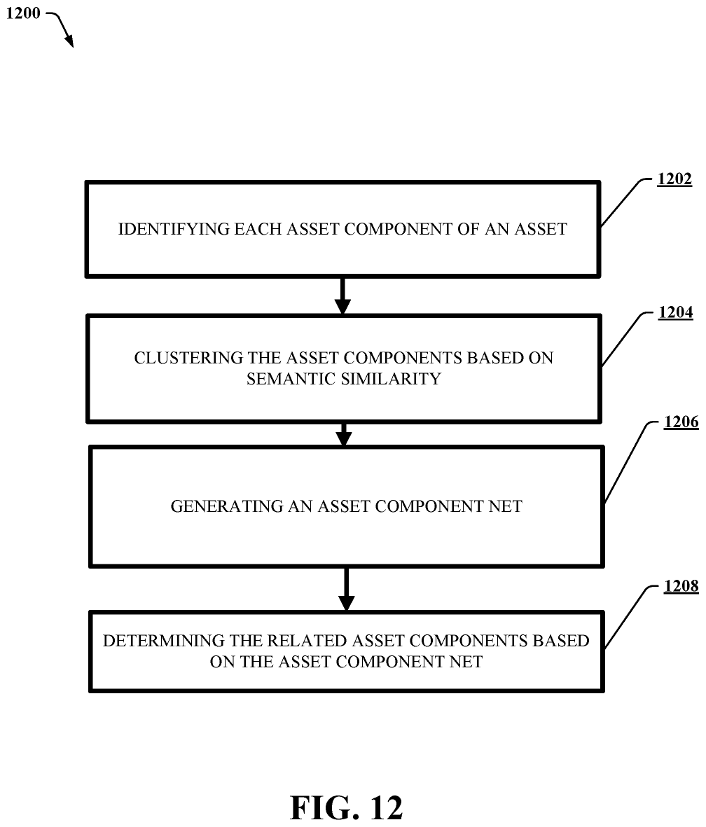

Next, FIG. 12 illustrates a flow diagram of an example, non-limiting method 1200 that can facilitate generation of an essentialized document that aids a technician in solving a problem with an asset, in accordance with one or more embodiments described herein. Repetitive description of like elements and/or processes employed in respective embodiments is omitted for sake of brevity. At 1202, the non-limiting method 1200 can comprise identifying (e.g., by asset net generator component 122) each asset component of an asset. At 1204, the non-limiting method 1200 can comprise clustering (e.g., by asset net generator component 122) the asset components based on semantic similarity. At 1206, the non-limiting method 1200 can comprise generating (e.g., by asset net generator component 122) an asset component net. At 1208 the non-limiting method 1200 can comprise determining (e.g., by customization component 114) the related asset components based on the asset component net.

Turning next to FIG. 13, a detailed description is provided of additional context for the one or more embodiments described herein at FIGS. 1-12.

FIG. 13 and the following discussion are intended to provide a brief, general description of a suitable computing environment 1300 in which one or more embodiments described herein at FIGS. 1-12 can be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as document essentializing code 1345. In addition to block 1345, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1345, as identified above), peripheral device set 1314 (including user interface (UI), device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1345 in persistent storage 1313.

COMMUNICATION FABRIC 1311 is the signal conduction paths that allow the various components of computer 1301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, the volatile memory is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface type operating systems that employ a kernel. The code included in block 1345 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1501 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on the user's computer, partly on the user's computer, as a stand-alone software package, partly on the user's computer or partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described herein with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality, and operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function(s). In one or more alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that the one or more embodiments herein also can be implemented in combination with other program modules. Generally, program modules include routines, programs, components, data structures or the like that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics or the like. The illustrated aspects can also be practiced in distributed computing environments in which tasks are performed by remote processing devices that are linked through a communications network. However, some, if not all aspects of the one or more embodiments can be practiced on stand-alone computers. In a distributed computing environment, program modules can be located in both local and remote memory storage devices.

As used in this application, the terms “component,” “system,” “platform,” “interface,” or the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing the one or more embodiments, but one of ordinary skill in the art can recognize that many further combinations and permutations of the one or more embodiments are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the one or more embodiments provided herein have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory that stores computer executable components; and
a processor that executes computer executable components stored in the memory, wherein the computer executable components comprise:
a problem definition component that receives a work order associated with a problem of an asset, determines critical factors of related work orders, and defines the problem of the asset based on the critical factors and the work order;
a scoring component that generates user scores indicating a skill level of a user tasked with resolving the problem of the asset for each asset component of the asset based on a user profile; and
a customization component that:
determines a task-required score based on the user scores for the asset components associated with the problem and the user scores for related asset components; and
generates a customization guide based on the task-required score.

2. The system of claim 1, wherein the computer executable components further comprise:
a document filter component that generates a coarse-grained document tree for each document in a document library based on predefined dimensions and matches the documents at a paragraph granularity based on the critical factors and related asset components, and performs fine-grained semantic analysis on the content of the matched documents at a sentence level; and
a document assembling component that generates an assembled document based on an integrity analysis and a semantic similarity analysis on the content of related paragraphs of the matched documents.

3. The system of claim 2, wherein the computer executable components further comprise:
a document essentializing component that generates an essentialized document based on the assembled document and the customization guide.

4. The system of claim 1, wherein the computer executable components further comprise:
an asset component net generator that identified each asset component of an asset and clusters the asset components based on semantic similarity to generate an asset component net.

5. The system of claim 4, wherein the customization component determines the related asset components based on the asset component net.

6. The system of claim 1, wherein the problem definition component analyzes related work orders based on a timeline associated with the related work orders and generates weighted determiners to determine the critical factors.

7. The system of claim 1, wherein the user profile comprises one or more of a group consisting of: historical work orders associated with the user, an amount of work experience of the user, a work log of the user, a self-assessment of the user, and review comments associated with the user.

8. The system of claim 2, wherein the document assembling component generates an assembled document by identifying paragraphs for the addition of a reference or other supplementary information.

9. The system of claim 3, wherein the document essentializing component prevents the insertion of redundant information to the essentialized document based on the assembled document.

10. The system of claim 3, wherein the document essentializing component generates the essentialized document by adding and omitting information to and from the essentialized document based on the customization guide.

11. A computer-implemented method, comprising:
receiving, by a system operably coupled to a processor, a work order associated with a problem of an asset;
determining, by the system, critical factors of related work orders;
defining, by the system, the problem of the asset based on the critical factors and the work order;
generating, by the system, user scores indicating a skill level of a user tasked with resolving the problem of the asset for each asset component of the asset based on a user profile;
determining, by the system, a task-required score based on the user scores for the asset components associated with the problem and the user scores for related asset components; and
generating, by the system, a customization guide based on the task-required score.

12. The computer-implemented method of claim 11, further comprising:
generating, by the system, a coarse-grained document tree for each document in a document library based on predefined dimensions and matches the documents at a paragraph granularity based on the critical factors and related asset components;
performing, by the system, fine-grained semantic analysis on the content of the matched documents at a sentence level; and
generating, by the system, an assembled document based on an integrity analysis and a semantic similarity analysis on the content of related paragraphs of the matched documents.

13. The computer-implemented method of claim 12, further comprising:
generating, by the system, an essentialized document based on the assembled document and the customization guide.

14. The computer-implemented method of claim 11, further comprising:
identifying, by the system, each asset component of an asset;
clustering, by the system, the asset components based on semantic similarity; and
generating, by the system, an asset component net.

15. The computer-implemented method of claim 14, further comprising:
determining, by the system, the related asset components based on the asset component net.

16. The computer-implemented method of claim 11, wherein determining critical factors comprises:
analyzing, by the system related work orders based on a timeline associated with the related work orders; and
generating, by the system, weighted determiners.

17. A computer program product facilitating the comparison of risk assessments for multiple artificial intelligence models, the computer program product comprising a computer readable storage medium having program instructions embodied therewith, the program instructions executable by a processor to cause the processor to:
receive a work order associated with a problem of an asset;
determine critical factors of related work orders;
define the problem of the asset based on the critical factors and the work order;
generate user scores indicating a skill level of a user tasked with resolving the problem of the asset for each asset component of the asset based on a user profile;
determine a task-required score based on the user scores for the asset components associated with the problem and the user scores for related asset components; and
generate a customization guide based on the task-required score.

18. The computer program product of claim 17, wherein the program instructions are further executable by the processor to cause the processor to:
generate a coarse-grained document tree for each document in a document library based on predefined dimensions and matches the documents at a paragraph granularity based on the critical factors and related asset components; and
perform fine-grained semantic analysis on the content of the matched documents at a sentence level.

19. The computer program product of claim 18, wherein the program instructions are further executable by the processor to cause the processor to:
generate an assembled document based on an integrity analysis and a semantic similarity analysis on the content of related paragraphs of the matched documents.

20. The computer program product of claim 19, wherein the program instructions are further executable by the processor to cause the processor to:
generate an essentialized document based on the assembled document and the customization guide.
